(19) United States
(12) Patent Application Publication
(10) Pub. No.: US 2023/0154022 A1
(43) Pub. Date: May 18, 2023

(54) METHOD FOR DETERMINING COORDINATES OF A POINT OF AN ELEMENT OF INTEREST IN THE REAL WORLD BASED ON COORDINATES OF SAID POINT IN AN IMAGE

(71) Applicant: IDEMIA IDENTITY & SECURITY FRANCE, Courbevoie (FR)

(72) Inventor: Pierre PERRAULT, Courbevoie (FR)

(73) Assignee: IDEMIA IDENTITY & SECURITY FRANCE, Courbevoie (FR)

(21) Appl. No.: 18/050,686

(22) Filed: Oct. 28, 2022

(30) Foreign Application Priority Data
Nov. 18, 2021 (FR) 21 12190

(51) Int. Cl. G06T 7/50; G06V 10/22

(52) U.S. Cl. CPC G06T 7/50; G06V 10/22

(57) ABSTRACT

A method for determining an element of interest referenced by image points, the real coordinates of a point of interest in the environment of the imaging device corresponding to an image point of the plurality of image points including selecting, in the image a noteworthy image point from among the plurality of image points, the noteworthy image point corresponding, in the real environment, to a noteworthy point for which the order of magnitude of the height is known, a predefined height being assigned to the height, calculating an absolute depth of the noteworthy image point based on a triplet of components of the noteworthy image point and on the predefined height, and determining the real coordinates of the point of interest in the real environment of the imaging device, based on a triplet of components of the image point corresponding to the point of interest and on the absolute depth.

The invention relates to the field of imaging using an imaging device, and relates more specifically to a method for determining coordinates of a point of an element of interest in the real world based on coordinates of said point in an image.

It is known from the prior art to use neural networks to generate disparity maps in order to estimate the depth of a point in an image, and make it possible to determine the coordinates of this point in the real world.

These neural networks do not give satisfactory results on wide-plane images originating from a surveillance video of a location since the imaging device is at a distance far greater than the real distances between the elements of interest in an image.

Furthermore, disparity maps do not make it possible to determine the absolute depth of a point in an image, but only the relative depth.

Certain networks that estimate the distance from an element of interest on the basis of the size of its bounding box are also known. This principle is well-suited to imaging devices that are located level with the ground, but is not readily applicable to situations with images originating from a surveillance video, in which the apparent size of an element of interest is also affected by the position of the imaging device.

The invention aims to solve the abovementioned problems from the prior art by proposing a method for determining the coordinates of a point of an element of interest in the real world using pixel coordinates of said point in the image and its relative depth with respect to a reference point by way of calculating an absolute depth of said reference point.

The invention relates to a method for determining, by way of a computer, based on an image taken by an imaging device and comprising an element of interest referenced by a plurality of image points, the real coordinates of a point of interest in the environment of the imaging device corresponding to an image point of the plurality of image points, each image point being characterized by a triplet of components comprising two-dimensional pixel coordinates and a relative depth with respect to a reference image point belonging to the plurality of image points, each image point corresponding, in the real environment, to a point with real coordinates comprising a height, the method comprising the following steps:
a step of selecting, in the image, by way of the computer, a noteworthy image point from among the plurality of image points, the noteworthy image point corresponding, in the real environment, to a noteworthy point for which the order of magnitude of the height is known, a predefined height being assigned to the height of the noteworthy image point,
a step of calculating, by way of the computer, an absolute depth of the noteworthy image point based on the triplet of components of the noteworthy image point and on the predefined height,
a step of determining, by way of the computer, the real coordinates of the point of interest in the real environment of the imaging device, based on the triplet of components of the image point corresponding to the point of interest and on the absolute depth.

According to one aspect of the invention, the selected noteworthy image point is located level with the ground, meaning that the predefined height is zero.

According to one aspect of the invention, the element of interest is a person standing on the ground.

According to one aspect of the invention, the element of interest is a person, the plurality of image points does not comprise any image point located level with the ground, the selected noteworthy image point is located level with said person's pelvis and the predefined height is a value between 65 cm and 85 cm.

According to one aspect of the invention, the element of interest is a person, the plurality of image points does not comprise any image point located level with the ground, the selected noteworthy image point is located level with said person's head and the predefined height is a value between 155 cm and 180 cm.

According to one aspect of the invention, the imaging device is characterized by predetermined calibration parameters comprising:
a transverse angle of inclination of the imaging device,
a focal length of the imaging device,
a height at which the imaging device is positioned.

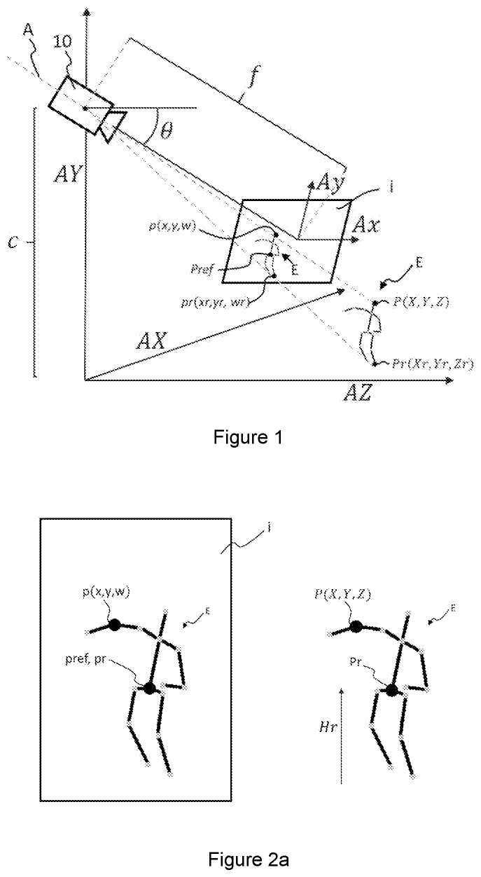

According to one aspect of the invention, the absolute depth is calculated using the following formula: wa=− cos(θ)·Zr+(c−Hr) sin(θ), where
wa is the absolute depth,
θ is the transverse angle of inclination of the imaging device,
c is the height at which the imaging device is positioned,
Hr is the predefined height of the noteworthy point,
Zr is a component of the real coordinates (Xr, Yr, Zr) of the noteworthy point in a terrestrial reference system as shown in FIG. 1.

According to one aspect of the invention, the calculation step comprises:
a sub-step of estimating, by way of the computer, the real coordinates of the noteworthy point in the real environment of the imaging device based on the calibration parameters, on the triplet of components of the noteworthy image point and on the predefined height,
a sub-step of calculating, by way of the computer, the absolute depth of the noteworthy image point based on the estimated real coordinates of the noteworthy point and on the calibration parameters.

According to one aspect of the invention, the determination step comprises:
a sub-step of transforming, by way of the computer, the triplet of components of the image point corresponding to the point of interest into a triplet of absolute components based on the absolute depth,
a sub-step of determining, by way of the computer, the real coordinates of the point of interest in the real environment of the imaging device, based on the triplet of absolute components and on the calibration parameters.

According to one aspect of the invention, the triplet of absolute components is determined using the following formulas:

x′=x, y′=y, w′=w+wa−wr,

where:
(x′, y′, w′) is the triplet of absolute components,
(x, y, w) is the triplet of components of the image point corresponding to the point of interest,
wa is the absolute depth,
wr is the relative depth of the noteworthy image point.

According to one aspect of the invention, the two-dimensional pixel coordinates of an image point are defined in an image reference system the origin of which is located in a centre of the image and the real coordinates of the point of interest are determined as follows:

$$X = \frac{{x}^{′}}{f} \cdot {w}^{′} \\ y = c - \frac{{y}^{′} \cdot {w}^{′} \cdot cos ( θ )}{f} - {w}^{′} \cdot sin ( θ ) \\ Z = \frac{{y}^{′} \cdot {w}^{′} \cdot sin ( θ )}{f} - {w}^{′} \cdot cos ( θ )$$

where:
(X, Y, Z) are the real coordinates of the point of interest,
(x′, y′, w′) is the triplet of absolute components,
θ is the transverse angle of inclination of the imaging device,
c is the height at which the imaging device is positioned,
f is the focal length of the imaging device.

The invention also relates to a computer program comprising program instructions implementing the steps of the determination method when the program instructions are executed by a computer.

Other advantages and features of the invention will become apparent upon reading the description and the drawings.

FIG. 1 shows a geometric model of an image reference frame and a real environment.

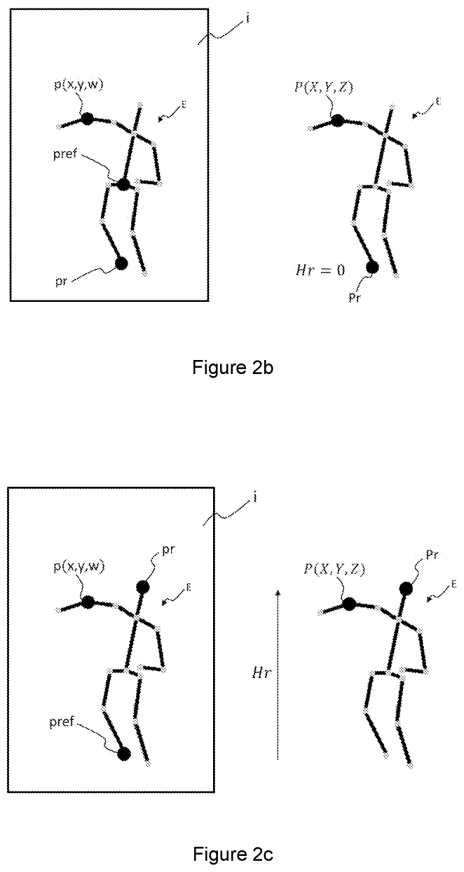

FIG. 2a shows an image comprising an element of interest corresponding to a person and referenced by a plurality of image points, and also the element of interest in the real world, according to a first exemplary embodiment.

FIG. 2b shows the same image as in FIG. 2a and the same element of interest in the real world, according to a second exemplary embodiment.

FIG. 2c shows the same image as in FIG. 2a and the same element of interest in the real world, according to a third exemplary embodiment.

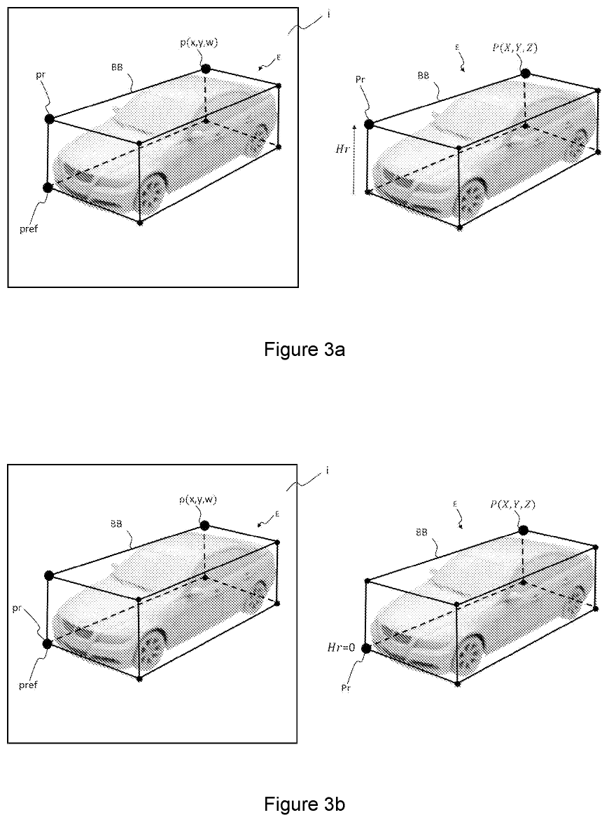

FIG. 3a shows an image comprising an element of interest corresponding to a vehicle and referenced by a plurality of image points, and also the element of interest in the real world, according to a fourth exemplary embodiment.

FIG. 3b shows the same image as in FIG. 3a and the same element of interest in the real world, according to a fifth exemplary embodiment.

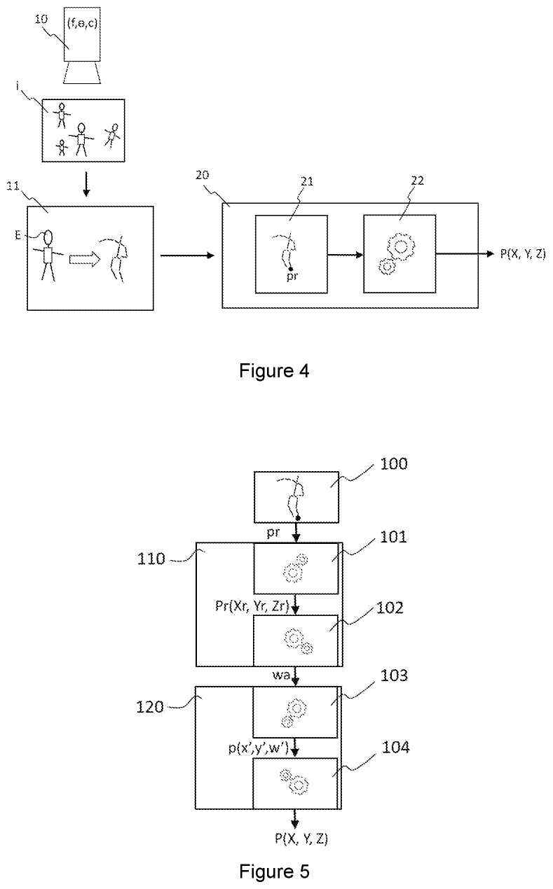

FIG. 4 illustrates one example of a system for implementing the method according to the invention.

FIG. 5 illustrates the steps of the method according to the invention.

FIG. 1 shows an imaging device 10 positioned at a height above the ground. The environment of the imaging device is referenced in the three-dimensional real world by a terrestrial reference frame the origin of which is a point on the ground vertical to the imaging device 10. The axes of the terrestrial reference frame comprise an axis AY oriented upwards and passing through the imaging device 10, and two axes AX, AZ located in the plane of the ground above which the imaging device 10 is positioned. The imaging device has the coordinates (X, Y, Z)=(0, c, 0) in the terrestrial reference system.

The imaging device 10 is characterized by predetermined calibration parameters comprising:
a transverse angle of inclination θ, that is to say the pitch angle defined by the angle between the main axis A of the imaging device 10 and a horizontal direction,
a focal length f,
a height cat which the imaging device 10 is positioned.

One or more calibration parameters f, θ, c are for example determined based on images from the imaging device 10.

One or more calibration parameters f, θ, c are for example measured in the real environment of the imaging device 10.

The calibration parameters f, θ, c for the imaging device 10 make it possible to match the spatial coordinates of a point in the field of the imaging device, referred to as “real” coordinates as they are expressed in a terrestrial reference frame, with the planar coordinates of the representation of this point in the image acquired by the imaging device, referred to as “image” coordinates, that is to say the projection thereof.

The field of view of the imaging device 10 contains an element of interest E, such as for example a standing person in FIG. 1. An image i taken by the imaging device 10 thus comprises the element of interest E, that is to say, more precisely, the image thereof.

The element of interest E is referenced in the image i by a plurality of image points p.

An element of interest is an object or a person that/who is of interest with regard to a target application. For example, in the context of a social distancing target application, an element of interest is a person. In the context of a target application for verifying distances in a road environment, an element of interest is a vehicle, a pedestrian or a cyclist. In the context of a target application for collision avoidance or analysis, an element of interest may also be an object such as a tree or a bollard.

For example, the element of interest is a person who is modelled by fifteen skeleton points, each skeleton point in the image corresponding to an image point p.

The plurality of image points p comprises a reference image point pref. In FIG. 1, the reference image point pref is located level with the person's pelvis.

A two-dimensional image reference system is defined in an image i acquired by the imaging device 10, The image reference system has the centre of the image i as origin and comprises two axes, a horizontal abscissa axis Ax and a vertical ordinate axis Ay.

In the image reference system, each image point p is characterized by a triplet of components (x, y, w) comprising two-dimensional pixel coordinates (x, y) and a relative depth w with respect to the reference image point pref.

Each image point p corresponds, in the real environment, to a point P with real coordinates (X, Y, Z), comprising a height Y associated with the upwardly oriented axis AY of the terrestrial reference frame.

The plurality of image points p furthermore comprises a noteworthy image point pr. In FIG. 1, the noteworthy image point is located level with a foot of the person.

In the image, the noteworthy image point pr is characterized by the triplet of components (xr, yr, wr).

In the real world, the noteworthy point Pr corresponding to the noteworthy image point pr has the real coordinates (Xr, Yr, Zh).

The noteworthy point Pr is noteworthy in that the order of magnitude of the height Yr is known. In the steps of the method of the invention, a predefined height Hr is assigned to the height Yr of the noteworthy image point. For example, the predefined height is an average of the known heights of the noteworthy point Pr associated with the element of interest.

For example, in the case of an element of interest corresponding to a person and a noteworthy point located level with the pelvis, the height Yr is of the order of magnitude of 70 cm, this corresponding to the order of magnitude of the average height of a person's pelvis.

For example, in the case of an element of interest corresponding to a person and a noteworthy point located level with the head, the height Yr is of the order of magnitude of 160 cm, this corresponding to the order of magnitude of the average size of a person.

Some assumptions are also advantageously made regarding the context:
the roll angle of the imaging device 10 is assumed to be negligible,
the yaw angle of the imaging device 10 is assumed to be negligible,
the distortion in an image i acquired by the imaging device 10 is assumed to be negligible,
the optical centre of the imaging device 10 corresponds to the centre of the image i,
the ground of the environment of the imaging device 10, in the field of view of the imaging device 10, is flat.

FIG. 2a, FIG. 2b and FIG. 2c illustrate, on the left-hand part, an image i comprising an element of interest E corresponding to a person, referenced by 15 image points resulting from a skeleton-point model. The element of interest E in the real world is shown in the right-hand part of each figure.

According to a first exemplary embodiment shown in FIG. 2a, each image point p is characterized by a triplet of components (x, y, w) comprising two-dimensional pixel coordinates (x, y) and a relative depth w with respect to a reference image point pref located level with the pelvis. The selected noteworthy image point pr is the same as the reference image point, that is to say located level with the pelvis. In the real world, the predefined height Hr of the noteworthy point Pr is for example equal to 70 cm.

According to a second exemplary embodiment shown in FIG. 2b, each image point p is characterized by a triplet of components (x, y, w) comprising two-dimensional pixel coordinates (x, y) and a relative depth w with respect to a reference image point pref located level with the pelvis. The selected noteworthy image point pr is located level with one of the person's feet, that is to say level with the ground. In the real world, the predefined height Hr of the noteworthy point Pr is equal to zero.

According to a third exemplary embodiment shown in FIG. 2c, each image point p is characterized by a triplet of components (x, y, w) comprising two-dimensional pixel coordinates (x, y) and a relative depth w with respect to a reference image point pref located level with the ground. The selected noteworthy image point pr is located level with the person's head. In the real world, the predefined height Hr of the noteworthy point Pr is for example equal to 160 cm.

FIG. 3a and FIG. 3b illustrate, on the left-hand part, an image i comprising an element of interest E corresponding to a motor vehicle, referenced by 8 image points resulting from a parallelepipedal delimiting envelope model. The element of interest E in the real world is shown in the right-hand part of each figure.

According to a fourth exemplary embodiment shown in FIG. 3a, each image point p is characterized by a triplet of components (x, y, w) comprising two-dimensional pixel coordinates (x, y) and a relative depth w with respect to a reference image point pref located level with the ground. The selected noteworthy image point pr is located in an upper corner of the delimiting envelope BB of the vehicle, that is to say at the same height as the roof of the vehicle. In the real world, the predefined height Hr of the noteworthy point Pr is for example equal to 170 cm.

According to a fifth exemplary embodiment shown in FIG. 3b, each image point p is characterized by a triplet of components (x, y, w) comprising two-dimensional pixel coordinates (x, y) and a relative depth w with respect to a reference image point pref located level with the ground. The selected noteworthy image point pr is identical to the reference point pref, that is to say level with the ground. In the real world, the predefined height Hr of the noteworthy point Pr is equal to zero.

FIG. 4 illustrates a system comprising an imaging device 10, an element of interest detector 11 and a computer 20.

The imaging device 10 is able to acquire images i of a scene of its environment. The imaging device 10 is preferably a video camera, but may be a photographic camera.

The element of interest detector 11 is configured to detect elements of interest E in an image i taken by the imaging device 10 and to determine key points of an element of interest, for example in order to generate a simplified model such as a fifteen-point skeleton for a person or a delimiting envelope BB for a motor vehicle. These key points are image points p in the image i.

The element of interest detector 11 may be split into two separate sub-devices able to communicate with one another, a first device being able to detect elements of interest E in the image i and a second device being able to determine key points of an element of interest detected by the first device, for example through regression.

The element of interest detector 11 generates, for each element of interest E detected in an image i, a plurality of image points p, each image point being associated with a triplet of components (x, y, w).

The computer 20 retrieves, for an element of interest E detected in an image i, the associated triplet of components (x, y, w). The two-dimensional coordinates (x, y) of a triplet of components (x, y, w) are able to be used by the computer 20 to execute the method of the invention, directly or after a potential change of reference system if the two-dimensional coordinates (x, y) are not referenced in the image reference system as described and illustrated in FIG. 1.

The computer 20 comprises a selector 21 able to select a noteworthy image point pr from among a plurality of image points p associated with an element of interest E and to associate therewith a predefined height Hr in the real world.

The computer 20 comprises an operator 22 able:
to calculate an absolute depth wa of the noteworthy image point pr based on the triplet of components (xr, yr, wr) of the noteworthy image point pr and on the predefined height Hr,
and to determine, for an image point p, the real coordinates (X, Y, Z) of the corresponding point in the real environment of the imaging device and called point of interest P, based on the triplet of components (x, y, w) of the image point (p) and on the absolute depth wa.

FIG. 5 illustrates the steps of the method according to the invention.

The method of the invention aims to determine, based on an image i taken by an imaging device 10 and comprising an element of interest E referenced by a plurality of image points p, the real coordinates (X, Y, Z) of a point of interest P in the environment of the imaging device 10 corresponding to an image point p of the plurality of image points p.

A point of interest P is a point for which the computer is interested in its coordinates in the real world, for example, in order to deduce therefrom a distance from another object of interest E.

Each image point p is characterized by a triplet of components (x, y, w) comprising two-dimensional pixel coordinates (x, y) and a relative depth w with respect to a reference image point pref belonging to the plurality of image points p. Each image point p corresponds, in the real environment, to a point P with real coordinates (X, Y, Z) comprising a height Y.

In a selection step 100, the computer 20 selects a noteworthy image point pr from among the plurality of image points p associated with the element of interest E, and assigns a predefined height Hr to the height Yr.

For example, the element of interest E corresponds to a person, the noteworthy image point pr is located level with a foot of the person, and the predefined height Hr of the noteworthy point Pr is equal to zero.

It is highly beneficial to choose a noteworthy image point pr located on the ground as the predefined height Hr of the noteworthy point Pr is equal to zero. The majority of elements of interest E in an image i are in contact with the ground: a motor vehicle, a pedestrian, a bicycle. Thus, to use the method of the invention to detect interactions between people or risks of collision between vehicles or a vehicle and a person, this choice of noteworthy image point pr may be applied in theory to all of the elements of interest.

However, in an image i, an element of interest E may be concealed for example by another element of interest E, thereby possibly making that part of the element of interest E in contact with the ground invisible in the image i.

An element of interest E is sometimes also referenced by image points p not comprising points on the ground. For example, a person is referenced by image points p originating from a skeleton-point model in which the foot points of the skeleton are located level with the ankles.

Thus, in the case of an element of interest E being a person standing on the ground, when the plurality of image points p does not comprise any image point p located level with the ground, the computer 20 may choose a noteworthy image point pr located for example level with said person's pelvis, or level with said person's head.

A noteworthy image point pr located level with a person's pelvis or head is noteworthy in that the height of the pelvis or the head of a standing person, even a moving person when the person is walking, varies little, and the order of magnitude is therefore known. It should be noted that such a noteworthy point may be selected by the computer 20 even if the plurality of image points p comprises a point located on the ground.

The predefined height Hr associated with a noteworthy image point pr located level with a person's head is preferably a value between 155 cm and 180 cm, for example 160 cm.

The predefined height Hr associated with a noteworthy image point pr located level with a person's pelvis is a value between 65 cm and 85 cm, for example 70 cm.

For example, the element of interest E corresponds to a motor vehicle or a bicycle, the noteworthy image point pr is located level with the bottom of a delimiting envelope BB aligned with a wheel of the motor vehicle or the bicycle in contact with the ground, and the predefined height Hr of the noteworthy point Pr is equal to zero.

For example, the element of interest E corresponds to a motor vehicle, the noteworthy image point pr is located level with the top of a delimiting envelope BB aligned with the roof of the motor vehicle, and the predefined height Hr of the noteworthy point Pr is equal to a value between 160 cm and 195 cm, for example equal to 170 cm.

In a calculation step 110, the computer 20 calculates an absolute depth wa of the noteworthy image point pr based on the triplet of components (xr, yr, wr) of the noteworthy image point pr and on the predefined height Hr.

In particular, the calculation step 110 comprises an estimation sub-step 101 and a calculation sub-step 102.

In the estimation sub-step 101, the computer 20 estimates the real coordinates (Xr, Yr, Zr) of the noteworthy point Pr in the real environment of the imaging device 10 based on the calibration parameters (f, θ, c), on the triplet of components (xr, yr, wr) of the noteworthy image point pr and on the predefined height Hr.

To estimate the coordinates (Xr, Yr, Zr) of the noteworthy point Pr in the real environment of the imaging device 10, use is made of the projection matrix P of the imaging device 10, which is defined based on the calibration parameters (f, θ, c) as follows:

$$P = [ \begin{matrix}f & 0 & 0 \\ 0 & f & 0 \\ 0 & 0 & 1\end{matrix} ] . [ \begin{matrix}1 & 0 & 0 \\ 0 & cos ( θ ) & - s in ( θ ) \\ 0 & sin ( θ ) & cos ( θ )\end{matrix} ] \cdot [ \begin{matrix}1 & 0 & 0 & 0 \\ 0 & 1 & 0 & - c \\ 0 & 0 & 1 & 0\end{matrix} ] \\ P = [ \begin{matrix}f & 0 & 0 & 0 \\ 0 & f \cdot cos ( θ ) & - f \cdot sin ( θ ) & - f \cdot c \cdot cos ( θ ) \\ 0 & sin ( θ ) & cos ( θ ) & - c \cdot sin ( θ )\end{matrix} ]$$

The terrestrial reference frame and the image reference system are as shown in FIG. 1.

An image point with two-dimensional coordinates (x, y) in the image reference system corresponds to a real point with coordinates (X, Y, Z) in the terrestrial reference frame, via the calibration parameters (f, θ, c).

More specifically, it is possible to obtain a homogeneous representation (xh, yh, wh) of an image point through multiplication by the projection matrix P of the homogeneous representation (X, Y, Z, 1) of a corresponding real point, using the following relationship:

$$[ \begin{matrix}x h \\ y h \\ w h\end{matrix} ] = P \cdot [ \begin{matrix}X \\ Y \\ Z \\ 1\end{matrix} ] = [ \begin{matrix}f & 0 & 0 & 0 \\ 0 & f \cdot cos ( θ ) & - f \cdot sin ( θ ) & - f \cdot c \cdot cos ( θ ) \\ 0 & sin ( θ ) & cos ( θ ) & - c \cdot sin ( θ )\end{matrix} ] \cdot [ \begin{matrix}X \\ Y \\ Z \\ 1\end{matrix} ] \\ [ \begin{matrix}x h \\ y h \\ w h\end{matrix} ] = [ \begin{matrix}f \cdot X \\ f \cdot cos ( θ ) \cdot Y - f \cdot sin ( θ ) \cdot Z - f \cdot c \cdot cos ( θ ) \\ sin ( θ ) \cdot Y + cos ( θ ) \cdot Z - c \cdot sin ( θ )\end{matrix} ]$$

The following Cartesian coordinates are obtained for an image point:

$$[ \begin{matrix}x \\ y\end{matrix} ] = [ \begin{matrix}\frac{f \cdot X}{sin ( θ ) \cdot Y + cos ( θ ) \cdot Z - c \cdot sin ( θ )} \\ \frac{f \cdot cos ( θ ) \cdot Y - f \cdot sin ( θ ) \cdot Z - f \cdot c \cdot cos ( θ )}{sin ( θ ) \cdot Y + cos ( θ ) \cdot Z - c \cdot sin ( θ )}\end{matrix} ]$$

Applied to the noteworthy point Pr, the starting step is isolating the second equation, in which only the coordinate Z is unknown, since it is known that Yr=Hr. Therefore:

$$Z r = \frac{f \cdot cos ( θ ) \cdot ( Hr - c ) - sin ( θ ) \cdot ( Hr - c ) \cdot yr}{cos ( θ ) \cdot yr + f \cdot sin ( θ )}$$

It is then possible to determine the coordinate Xr via the first equation:

$$X r = xr \cdot \frac{cos ( θ ) \cdot Zr - ( c - Hr ) \cdot sin ( θ )}{f}$$

In the calculation sub-step 102, the computer 20 calculates the absolute depth wa of the noteworthy image point pr based on the estimated real coordinates (Xr, Yr, Zr) of the noteworthy point Pr and on the calibration parameters (f, θ, c).

The absolute depth wa is calculated using the formula below, established using geometric transformations of the terrestrial reference system comprising a translation so as to place the origin level with the imaging device, and a rotation so as to align with the optical axis A of the imaging device 10:

wa=−cos(θ)·Zr+(c−Hr)·sin(θ).

In a determination step 120, the computer determines the real coordinates (X, Y, Z) of the point of interest P in the real environment of the imaging device 10, based on the triplet of components (x, y, w) of the image point p corresponding to the point of interest P and on the absolute depth wa.

In particular, the determination step 120 comprises a transformation sub-step 103 and a determination sub-step 104.

In the transformation sub-step 103, the computer 20 transforms the triplet of components (x, y, w) of the image point p corresponding to the point of interest P into a triplet of absolute components (x′, y′, w′) based on the absolute depth wa.

The triplet of absolute components (x′, y′, w′) is determined using the following formulas:

x′=x, y′=y, w′=w+wa−wr.

In the determination sub-step 104, the computer determines the real coordinates (X, Y, Z) of the point of interest P in the real environment of the imaging device, based on the triplet of absolute components (x′, y′, w′) and on the calibration parameters (f, θ, c).

The real coordinates (X, Y, Z) of the point of interest (P) are determined as follows:

$$X = \frac{{x}^{′}}{f} \cdot {w}^{′} \\ y = c - \frac{{y}^{′} \cdot {w}^{′} \cdot cos ( θ )}{f} - {w}^{′} \cdot sin ( θ ) \\ Z = \frac{{y}^{′} \cdot {w}^{′} \cdot sin ( θ )}{f} - {w}^{′} \cdot cos ( θ )$$

These equations are the result of two steps: a first step that multiplies the terms x′ and y′ by the quotient w′/f in order to convert the pixels into real distances, and then a second step that corresponds to an inverse transformation to the one mentioned when calculating the absolute depth wa.

The units in relation to the above equations are as follows:
the predefined height Hr of the noteworthy point Pr is in centimetres,
the focal length f of the imaging device 10 is in pixels,
the angle A of the imaging device 10 is in radians,
the height c of the imaging device 10 is in centimetres,
the two-dimensional pixel coordinates (x, y), (x′, y′), (xr, yr) of a triplet of components of an image point p, pr are in pixels,
the relative depths w, wr and absolute depth wa are in centimetres,
the real coordinates (X, Y, Z), (Xr, Yr, Zr) of the point of interest P and of the noteworthy point Pr are in centimetres.

The method of the invention makes it possible to calculate the real coordinates of points relating to elements of interest E captured in an image by an imaging device.

This makes it possible for example to estimate distances between elements of interest and to deduce therefrom information about interactions between people or distances between people and objects such as vehicles or else distances between objects such as vehicles. It is thus possible with such a method to verify compliance with social distancing between people or to analyse dangerously close situations between multiple elements of interest.

1. A method for determining, by way of a computer, based on an image taken by an imaging device, the image including an element of interest referenced by a plurality of image points, real coordinates of a point of interest in environment of the imaging device corresponding to an image point of the plurality of image points, each image point having a triplet of components including two-dimensional pixel coordinates and a relative depth with respect to a reference image point belonging to the plurality of image points, each image point corresponding, in real environment, to a point with real coordinates having a height, the imaging device having predetermined calibration parameters including:
a transverse angle of inclination of the imaging device,
a focal length of the imaging device,
a height at which the imaging device is positioned,
the method comprising:
selecting, in the image, by way of the computer, a noteworthy image point from among the plurality of image points, the noteworthy image point corresponding, in the real environment, to a noteworthy point for which order of magnitude of the height is known, a predefined height being assigned to the height;
calculating, by way of the computer, an absolute depth of the noteworthy image point based on the triplet of components of the noteworthy image point and on the predefined height; and
determining, by way of the computer, the real coordinates of the point of interest in the real environment of the imaging device, based on the triplet of components of the image point corresponding to the point of interest and on the absolute depth.

2. The method according to claim 1, wherein the selected noteworthy image point is located level with the ground such that the predefined height is zero.

3. The method according to claim 1, wherein the element of interest is a person standing on the ground, the plurality of image points not having any image point located level with the ground, the selected noteworthy image point being located either: level with said person's pelvis, the predefined height being a value between 65 cm and 85 cm, or level with said person's head, the predefined height being a value between 155 cm and 180 cm.

4. The method according to claim 1, wherein the absolute depth is calculated using formula:
wa=−cos(θ)·Zr+(c−Hr)·sin(θ), where
wa is the absolute depth,
θ is the transverse angle of inclination of the imaging device,
c is the height at which the imaging device is positioned,
Hr is the predefined height of the noteworthy point, and
Zr is a component of the real coordinates of the noteworthy point.

5. The method according to claim 1, wherein the calculation further comprises:
estimating, by way of the computer, the real coordinates of the noteworthy point in the real environment of the imaging device based on the calibration parameters, on the triplet of components of the noteworthy image point and on the predefined height, and
calculating, by way of the computer, the absolute depth of the noteworthy image point based on the estimated real coordinates of the noteworthy point and on the calibration parameters.

6. The method according to claim 1, wherein the determination further comprises:
transforming, by way of the computer, the triplet of components of the image point corresponding to the point of interest into a triplet of absolute components based on the absolute depth, and
determining, by way of the computer, the real coordinates of the point of interest in the real environment of the imaging device, based on the triplet of absolute components and on the calibration parameters.

7. The method according to claim 6, wherein the triplet of absolute components is determined using formulas:
x′=x, y′=y and w′=w+wa−wr, where
(x′, y′, w′) is the triplet of absolute components,
(x, y, w) is the triplet of components of the image point corresponding to the point of interest,
wa is the absolute depth, and
wr is the relative depth of the noteworthy image point.

8. The method according to claim 6, wherein the two-dimensional pixel coordinates of an image point is defined in an image reference system, an origin of which is located in a center of the image, the real coordinates of the point of interest being determined as follows:
$$X = \frac{{x}^{′}}{f} \cdot {w}^{′} \\ y = c - \frac{{y}^{′} \cdot {w}^{′} \cdot cos ( θ )}{f} - {w}^{′} \cdot sin ( θ ) \\ Z = \frac{{y}^{′} \cdot {w}^{′} \cdot sin ( θ )}{f} - {w}^{′} \cdot cos ( θ )$$
where:
(X, Y, Z) are the real coordinates of the point of interest,
(x′, y′, w′) is the triplet of absolute components,
θ is the transverse angle of inclination of the imaging device,
c is the height at which the imaging device is positioned, and
f is the focal length of the imaging device.

9. A non-transitory computer program product comprising program instructions implementing the determination method according to claim 1 when the program instructions are executed by a computer.
